(19) United States
(12) Patent Application Publication
(10) Pub. No.: US 2017/0161832 A1
(43) Pub. Date: Jun. 8, 2017

(54) SYSTEM AND METHOD FOR TRACKING STOCK FLUCTUATIONS

(71) Applicants: Matthew T. Dennehy, Remsenburg, NY (US); Stephen E. Feldman, New York, NY (US)

(72) Inventors: Matthew T. Dennehy, Remsenburg, NY (US); Stephen E. Feldman, New York, NY (US)

(21) Appl. No.: 15/372,272

(22) Filed: Dec. 7, 2016

Related U.S. Application Data
(60) Provisional application No. 62/264,666, filed on Dec. 8, 2015.

(51) Int. Cl. G06Q 40/04; G06Q 30/02

(52) U.S. Cl. CPC G06Q 40/04; G06Q 30/0201; G06Q 50/01

(57) ABSTRACT

The specification relates to a method that can access an archive of internet traffic representing a defined period of time; receive internet traffic terms representing publicly traded companies of a first group, the first group including publicly traded companies that had an increase in internet traffic during the defined period of time and whose stock price rose during the defined period of time; receive internet traffic terms representing publicly traded companies of a second group, the second group including publicly traded companies that had an increase in internet traffic during the defined period of time and whose stock price fell during the defined period of time; use a computer-implemented algorithm to determine internet traffic terms that discriminate between the first group and the second group; and establish a classification model based upon the internet traffic terms that discriminate between the first and second group.

### CROSS REFERENCE TO RELATED APPLICATION

This application depends from U.S. Provisional Pat. App. Ser. No. 62/264,666 filed on Dec. 8, 2015, which is pending. The patent application identified above is incorporated here by reference in its entirety to provide continuity of disclosure.

### BACKGROUND

The disclosed technology relates generally to a system and method for tracking stock fluctuations.

Stock trading is a worldwide business that obtains insight into a company before buying and selling its stock. There are numerous ways to obtain this insight, for example, research of the company and make a determination if the stock is moving up or down. Any advantage in honing your research skills can increase the probability that your stock pick is correct. There is always a need to perfect research techniques.

### SUMMARY

This specification describes technologies relating to a system and method for tracking stock fluctuations.

In one implementation, a method can comprise the steps of: accessing an archive of internet traffic representing a defined period of time; receiving internet traffic terms representing publicly traded companies of a first group, the first group including publicly traded companies that had an increase in internet traffic during the defined period of time and whose stock price rose during the defined period of time; receiving internet traffic terms representing publicly traded companies of a second group, the second group including publicly traded companies that had an increase in internet traffic during the defined period of time and whose stock price fell during the defined period of time; using a computer-implemented algorithm to determine internet traffic terms that discriminate between the first group and the second group; establishing a classification model based upon the internet traffic terms that discriminate between the first and second group.

In some implementations, the method can further comprise the steps of: tracking publicly traded companies for determining when in increase in internet traffic is occurring for a particular publicly traded company; analyzing internet traffic terms associated with the particular publicly traded company with reference to the terms of the classification model; and returning a determination delineating if the particular publicly traded company is associated with the first group or the second group.

The advantages of the disclosed technology is obtaining insight from a company from multiple resources and obtaining results with a high probability of success.

In another implementation, a method can comprise the steps of: accessing an archive of social media traffic representing a defined period of time; social media traffic representing publicly traded companies of a first group, the first group including publicly traded companies that had an increase in social media traffic during the defined period of time and whose stock price rose during the defined period of time; receiving social media traffic terms representing publicly traded companies of a second group, the second group including publicly traded companies that had an increase in social media traffic during the defined period of time and whose stock price fell during the defined period of time; using a computer-implemented algorithm to determine social media traffic terms that discriminate between the first group and the second group; establishing a classification model based upon the social media traffic that discriminate between the first and second group.

In some implementations, the method can further comprise the steps of: tracking publicly traded companies for determining when in increase in social media traffic is occurring for a particular publicly traded company; analyzing social media traffic terms associated with the particular publicly traded company with reference to the terms of the classification model; and returning a determination delineating if the particular publicly traded company is associated with the first group or the second group.

The advantages of the disclosed technology is obtaining insight for a company from social networks and obtaining investment information with a high probability of success.

### BRIEF DESCRIPTION OF THE DRAWINGS

FIG. 1 is a block diagram of an example of a system used with the disclosed technology; and

FIG. 2 is a block diagram of an example of a system used with the disclosed technology.

### DETAILED DESCRIPTION

This specification describes technologies relating to a system and method for tracking stock fluctuations. In other words, the disclosed technology gives an educated guess on if a stock price is about to move lower or higher based on internet traffic, e.g., post on social media, post on blogs, search terms given to search engines and any other data that can be collected from the internet regarding a particular publically traded company.

By analyzing past internet traffic data on publicly traded companies, a computer learning algorithm can identify terms that indicate if the past internet traffic was positive or negative regarding a company or its stock. Applying these identified terms to real-time or present day internet traffic an investor can identify companies whose stock price may rise or fall within a few hours to several days in advance. In other words, the disclosed technology analyzes internet traffic using a classification model obtained from past internet traffic, and makes a determination if the stock price is going to rise or fall.

In one implementation, a number of companies whose stock price, in the past, have risen or fell are chosen. Two repositories are established. The first repository contains companies whose stock rose within a defined period of time, e.g., two months, two weeks, two days. Once these companied have been established any and all internet traffic containing the company name or stock symbol is aggregated into the repository. This pool of companies and associated internet traffic are considered a positive sample. In other words, internet traffic associated with these companies can contain attributes that the company stock is going to rise.

The second repository contains companies whose stock fell within a defined period of time, e.g., two months, two weeks, two days. Once these companies have been established any and all internet traffic containing the company name or stock symbol is aggregated into the second repository. This pool of terms is considered a negative sample. In other words, internet traffic associated with these companies can contain attributes that the company stock is going to fall.

The internet traffic associated with the both the positive and negative samples are parsed. As an example, the system can receive the internet traffic associated with these companies and transform the web traffic into a parsable data file. The computing system can audit and verify the data contained within the parsable data file to ensure all the data within the parsable data file is maintained in a consistent format. Once the parsable data files are completed, the parsable data file can be received by a computing system and stored in the proper repository.

The parsable data files are sent to a machine learning algorithm in order to define a classification model. In some implementations, the machine learning algorithm can use ensemble learning techniques, but any type of machine learning technique can be used.

Ensemble learning is a machine learning technique where multiple algorithms are trained to solve the same problem. In contrast to ordinary machine learning approaches that try to learn one hypothesis from training data. Ensemble methods try to construct a set of hypotheses and combine them into one useable model. That is, an ensemble is a supervised learning algorithm that can be trained and then used to make predictions. The trained ensemble, therefore, represents a single hypothesis or model.

The disclosed technology will use the positive parsable data files as samples representative of data that the trained system should classify as positive, e.g. belonging to the object class of companies whose stock price rose, and the negative parsable data file as samples representative of data that the systems should classify as negative, e.g. belonging to the object class of companies whose stock price fell. By providing this set of known positive samples and this set of known negative samples, the computerized system can “learn” features of the positive samples that are not present in the negative samples and vice versa. The system can then look for these features in an unknown sample, and when they are present or absent, declare that the sample is a positive or negative sample as the case can be. The process of providing test samples to the system and allowing or “teaching” the system to learn prominent features is known as training the classifier.

Specifically, training an object classification or object detection system involves extracting features in either a supervised or unsupervised manner to learn the differences and similarities between the positive and negative samples. Once determined, these indicators can be applied to new samples to determine whether they should be classified as belonging to the positive object class or belonging to the negative object class.

In some implementations, the negative and positive parsable data file can be sent to an ensemble using a boosting method. Boosting involves incrementally building an ensemble by training each new model instance to emphasize the training instances that previous models mis-classified. The boosting systems function then determines attributes that discriminate between the positive and negative parsable data file. The boosting system establishes a classification model having a set of weighted attributes. In other words, the positive and negative samples are compared to each other and the attributes of the first group are compared to the attributes of the second group. The system tracks and analyzes these likenesses and differences using the machine learning algorithm to establish a classifier. This classifier contains weighted attributes that the algorithm considers indicators (attributes) that give the best performance for a classification model.

As mentioned above, the system creates a classification model having a set of weighted results for each attribute. It is worthy to note that the more positive and negative resumes added to the repositories the better the classification model will be.

In use, internet traffic for a particular company can be aggregated and parsed into a newly received parsable data file, e.g., internet traffic for the last 24 hours. This newly received parsable data file can be tested against the classification model. The system can return a result determining if the newly received parsable data file is a positive parsable data file or a negative parsable data file with respect to the classification model.

The particular company to be analyzed can be determined based on an increase in the internet traffic for that company for a defined period of time. For example, if the internet traffic for a company increases by a defined threshold of 10% or higher for a period of 24 or more hours, internet traffic for that time period can be aggregated and an analysis performed. In another example, the particular company to be analyzed can be determined based on an increase in newspaper articles related to the company.

Please note, the above are examples and any number of factors can be used to run an analysis on a particular company. In another example, advertising billboards can have facial recognition technology to capture images of a person's facial feature when viewing a stock name. If a large number of people, based on threshold percentages, view the billboard positively or negatively an analysis can be performed.

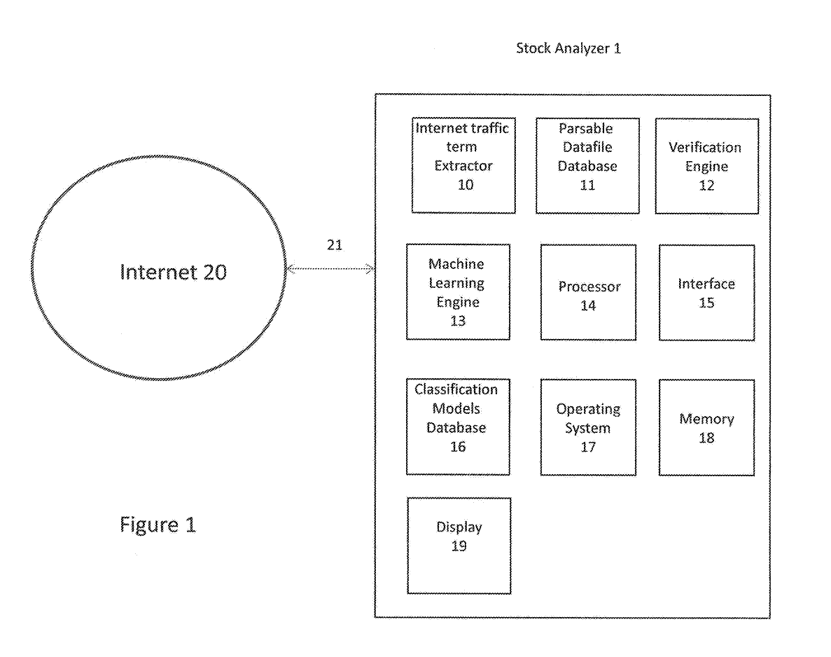

FIG. 1 is a schematic diagram of an example of a stock analyzer 1. The stock analyzer 1 can be a server that includes an internet term extractor 10, parsable data file database 11, verification engine 12, machine learning engine 13, processor 14, interface 15, classification model database 16, operating system 17, memory 18 and display 19.

The stock analyzer 1 can be connected to the internet 20 over connection 21. In some implementations, the system of FIG. 1 can include hardware as shown in FIG. 1 and also code for machine learning, code for tracking companies based on increase of internet traffic and code for determining positive and negative samples from the internet traffic.

The operating system 17 can be multi-user, multiprocessing, multitasking, multithreading, real-time and the like. The operating system 17 may perform basic tasks, including but not limited to: recognizing input from the interface 15; sending output to display device 19; keeping track of files and directories on computer-readable mediums 11, 16, 18 (e.g., memory or a storage device); controlling peripheral devices (e.g., disk drives, printers, etc.); and managing traffic on the one or more buses 21.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of the disclosed technology or of what can be claimed, but rather as descriptions of features specific to particular implementations of the disclosed technology. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. In some cases, the actions recited in the claims can be performed in a different order and still achieve desirable results. Moreover, the separation of various system components in the implementations described above should not be understood as requiring such separation in all implementations, and it should be understood that the described program components and systems can generally be integrated together in a single software product or packaged into multiple software products.

This specification also describes technologies relating to a system and method for tracking stock fluctuations. In other words, the disclosed technology gives an educated guess on if a stock price is about to move lower or higher based on social media traffic regarding a particular publicly traded company. Social media traffic is web traffic emanating from any website or application that enables its users to create and share content or to participate in social networking.

By analyzing past social media traffic on publicly traded companies, a computer learning algorithm can identify terms that indicate if the past social media traffic was positive or negative regarding a company or its stock. Applying these identified terms to real-time or present day social media traffic an investor can identify companies whose stock price may rise or fall within a few hours to several days in advance. In other words, the disclosed technology analyzes social media traffic using a classification model obtained from past social media traffic, and makes a determination if the stock price is going to rise or fall.

In one implementation, a number of companies whose stock price, in the past, have risen or fell are chosen. Two repositories are established. The first repository contains companies whose stock rose within a defined period of time, e.g., two months, two weeks, two days. Once these companied have been established any and all social media traffic containing the company name, stock symbol or company products is aggregated into the repository. This pool of companies and associated social media traffic are considered a positive sample. In other words, social media traffic associated with these companies can contain attributes that the company stock is going to rise.

The second repository contains companies whose stock fell within a defined period of time, e.g., two months, two weeks, two days. Once these companies have been established any and all social media traffic containing the company name or stock symbol is aggregated into the second repository. This pool of terms is considered a negative sample. In other words, social media traffic associated with these companies can contain attributes that the company stock is going to fall.

The social media traffic associated with the both the positive and negative samples are parsed. As an example, the system can receive the social media traffic associated with these companies and transform the social media traffic into a parsable data file. The computing system can audit and verify the data contained within the parsable data file to ensure all the data within the parsable data file is maintained in a consistent format. Once the parsable data files are completed, the parsable data file can be received by a computing system and stored in the proper repository.

The parsable data files are sent to a machine learning algorithm in order to define a classification model. In some implementations, the machine learning algorithm can use ensemble learning techniques, but any type of machine learning technique can be used.

Ensemble learning is a machine learning technique where multiple algorithms are trained to solve the same problem. In contrast to ordinary machine learning approaches that try to learn one hypothesis from training data. Ensemble methods try to construct a set of hypotheses and combine them into one useable model. That is, an ensemble is a supervised learning algorithm that can be trained and then used to make predictions. The trained ensemble, therefore, represents a single hypothesis or model.

The disclosed technology will use the positive parsable data files as samples representative of data that the trained system should classify as positive, e.g. belonging to the object class of companies whose stock price rose, and the negative parsable data file as samples representative of data that the systems should classify as negative, e.g. belonging to the object class of companies whose stock price fell. By providing this set of known positive samples and this set of known negative samples, the computerized system can “learn” features of the positive samples that are not present in the negative samples and vice versa. The system can then look for these features in an unknown sample, and when they are present or absent, declare that the sample is a positive or negative sample as the case can be. The process of providing test samples to the system and allowing or “teaching” the system to learn prominent features is known as training the classifier.

Specifically, training an object classification or object detection system involves extracting features in either a supervised or unsupervised manner to learn the differences and similarities between the positive and negative samples. Once determined, these indicators can be applied to new samples to determine whether they should be classified as belonging to the positive object class or belonging to the negative object class.

In some implementations, the negative and positive parsable data file can be sent to an ensemble using a boosting method. Boosting involves incrementally building an ensemble by training each new model instance to emphasize the training instances that previous models mis-classified. The boosting systems function then determines attributes that discriminate between the positive and negative parsable data file. The boosting system establishes a classification model having a set of weighted attributes. In other words, the positive and negative samples are compared to each other and the attributes of the first group are compared to the attributes of the second group. The system tracks and analyzes these likenesses and differences using the machine learning algorithm to establish a classifier. This classifier contains weighted attributes that the algorithm considers indicators (attributes) that give the best performance for a classification model.

As mentioned above, the system creates a classification model having a set of weighted results for each attribute. It is worthy to note that the more positive and negative samples added to the repositories the better the classification model will be.

In use, social media traffic for a particular company can be aggregated and parsed into a newly received parsable data file, e.g., internet traffic for the last 24 hours. This newly received parsable data file can be tested against the classification model. The system can return a result determining if the newly received parsable data file is a positive parsable data file or a negative parsable data file with respect to the classification model.

The particular company to be analyzed can be determined based on an increase in the social media traffic for that company for a defined period of time. For example, if the social media traffic for a company increases by a defined threshold of 10% or higher for a period of 24 or more hours, social media traffic for that time period can be aggregated and an analysis performed. In another example, the particular company to be analyzed can be determined based on an increase in newspaper articles related to the company.

Please note, the above are examples and any number of factors can be used to run an analysis on a particular company. In another example, advertising billboards can have facial recognition technology to capture images of a person's facial feature when viewing a stock name. If a large number of people, based on threshold percentages, view the billboard positively or negatively an analysis can be performed.

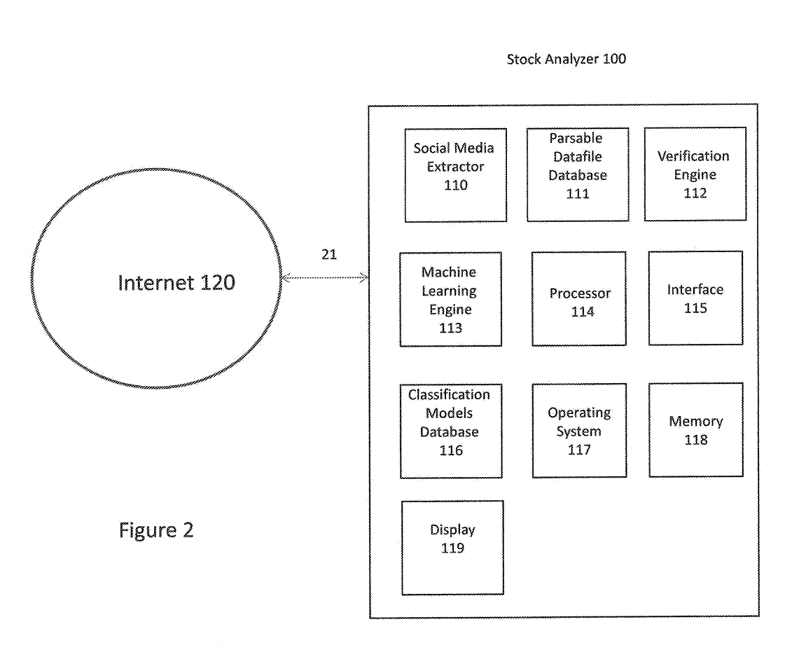

FIG. 2 is a schematic diagram of an example of a stock analyzer 100. The stock analyzer 100 can be a server that includes an social media extractor 110, parsable data file database 111, verification engine 112, machine learning engine 113, processor 114, interface 115, classification model database 116, operating system 117, memory 118 and display 119.

The stock analyzer 100 can be connected to the internet 120 over connection 121. In some implementations, the system of FIG. 2 can include hardware as shown in FIG. 2 and also code for machine learning, code for tracking companies based on increase of social media traffic and code for determining positive and negative samples from the social media traffic.

The operating system 117 can be multi-user, multiprocessing, multitasking, multithreading, real-time and the like. The operating system 117 may perform basic tasks, including but not limited to: recognizing input from the interface 115; sending output to display device 119; keeping track of files and directories on computer-readable mediums 111, 116, 118 (e.g., memory or a storage device); controlling peripheral devices (e.g., disk drives, printers, etc.); and managing traffic on the one or more buses 121.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of the disclosed technology or of what can be claimed, but rather as descriptions of features specific to particular implementations of the disclosed technology. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. In some cases, the actions recited in the claims can be performed in a different order and still achieve desirable results. Moreover, the separation of various system components in the implementations described above should not be understood as requiring such separation in all implementations, and it should be understood that the described program components and systems can generally be integrated together in a single software product or packaged into multiple software products.

In another implementation, the disclosed technology can use the identified terms and apply a mathematical formula, for example, based on speed, embedded in an algorithm to predict stock movements and desirability. Positive or negative terms can be weighted based on frequency and strength. Some of the terms can be as follows:

| | |
|---|---|
| Success | Time to finalize business plan |
| | Time to assemble a team |
| | Time to put own money and relatives' money in company |
| | Time to execute business plan |
| | Time to obtain angel funding |
| | Time to get crowdfunding |
| | Time to obtain initial round of funding |
| | Time to look in to getting additional funding |
| | Time to go public |
| | Time for first sale of product |
| | Time for follow through |
| | Time for initial impact of product on market-correct time |
| | Time to obtain predicted market share |
| | Time for first profit |
| | Time to react to crises-flexibility |
| | Time for increase in market share |
| | Time in business for CEO |
| | Time in business for competitors |
| | Time for public to appreciate influences of products |
| | compared to competitors |
| | Time for patents of company to be important to competitors |
| | Time CEO begins to live expensively |
| | Has CEO brought in friends to company |
| Market | Time to obtain initial market share |
| Share | Time to increase market share |
| Prediction | Times predicted for financial and sales milestones |
| | Actual times for financial and sales milestone |
| | Time (lower or higher) then prediction of milestones |
| | Time to change market share |
| | Social media hits on financial and sales milestones |
| Negatives | Time to respond to negative issues |
| | Time to ask for help after need arises |
| | Time Company pivots to new areas if initial business is |
| | failing |
| Risk | Time for risks to come to fruition |
| Products | Time for competition to copy |
| | Time for new products to succeed |
| CEO | Time of experience |
| | Time in prior companies |
| | Time to imitate new products |
| | Social media |
| | Setting standard for business and new products |
| | Patents |
| | New products |
| | Social media |
| Credibility | Predictions successful |
| | Earnings and sales predictions |
| | Integrity |
| Truthfulness | Confidence |
| | Trusted by-customers |
| | Trusted by-employees |

The foregoing Detailed Description is to be understood as being in every respect illustrative, but not restrictive, and the scope of the disclosed technology disclosed herein is not to be determined from the Detailed Description, but rather from the claims as interpreted according to the full breadth permitted by the patent laws. It is to be understood that the implementations shown and described herein are only illustrative of the principles of the disclosed technology and that various modifications can be implemented without departing from the scope and spirit of the disclosed technology.

1. A method comprising the steps of:
accessing an archive of internet traffic representing a defined period of time;
receiving internet traffic terms representing publicly traded companies of a first group, the first group including publicly traded companies that had an increase in internet traffic during the defined period of time and whose stock price rose during the defined period of time;
receiving internet traffic terms representing publicly traded companies of a second group, the second group including publicly traded companies that had an increase in internet traffic during the defined period of time and whose stock price fell during the defined period of time;
using a computer-implemented algorithm to determine internet traffic terms that discriminate between the first group and the second group; and
establishing a classification model based upon the internet traffic terms that discriminate between the first and second group.

2. The method of claim 1 further comprising the steps of:
tracking publicly traded companies for determining when in increase in internet traffic is occurring for a particular publicly traded company;
analyzing internet traffic terms associated with the particular publicly traded company with reference to the terms of the classification model; and
returning a determination delineating if the particular publicly traded company is associated with the first group or the second group.

3. A method comprising the steps of:
accessing an archive of social media traffic representing a defined period of time;
receiving social media traffic terms representing publicly traded companies of a first group, the first group including publicly traded companies that had an increase in social media traffic during the defined period of time and whose stock price rose during the defined period of time;
receiving social media traffic terms representing publicly traded companies of a second group, the second group including publicly traded companies that had an increase in social media traffic during the defined period of time and whose stock price fell during the defined period of time;
using a computer-implemented algorithm to determine social media traffic terms that discriminate between the first group and the second group; and
establishing a classification model based upon the social media traffic terms that discriminate between the first and second group.

4. The method of claim 3 further comprising the steps of:
tracking publicly traded companies for determining when in increase in social media traffic is occurring for a particular publicly traded company;
analyzing social media traffic terms associated with the particular publicly traded company with reference to the terms of the classification model; and
returning a determination delineating if the particular publicly traded company is associated with the first group or the second group.
